(19) United States
(12) Patent Application Publication
(10) Pub. No.: US 2016/0109123 A1
(43) Pub. Date: Apr. 21, 2016

(54) METHOD OF OPERATING A FURNACE

(71) Applicant: Glencore Technology Pty Limited, Queensland (AU)

(72) Inventors: Alistair Burrows, Queensland (AU); Philip Arthur, Queensland (AU)

(21) Appl. No.: 14/782,034

(22) PCT Filed: May 1, 2014
(86) PCT No.: PCT/AU2014/050026

§ 371 Date: Oct. 2, 2015

(30) Foreign Application Priority Data
May 3, 2013 (AU) 2013901566

(51) Int. Cl. F23K 1/02; F23C 1/10; F23K 3/00; F27D 3/18

(52) U.S. Cl. CPC F23K 1/02; F27D 3/18; F23C 1/10; F23K 3/00; F27D 2003/185; F27D 2003/168

(57) ABSTRACT

A method of operating a furnace wherein a slurry containing carbonaceous material is added to the furnace as a fuel and/or reducing agent

### TECHNICAL FIELD

The present invention relates to a method of operating a furnace, particularly a furnace including a lance. In particular, the present invention relates to a method of operating a furnace wherein a slurry of carbonaceous material is added to the furnace as a fuel and/or a reducing agent.

### BACKGROUND ART

Carbonaceous materials are added to many metallurgical furnaces to provide a fuel and/or a reducing agent for a pyrometallurgical process. These materials can include fuel oils, diesel, natural gas, petroleum coke, metallurgical coke, lignites or bituminous coal, and the materials are typically chosen for their high calorific value.

The carbonaceous materials are usually injected into a metallurgical furnace through a lance or tuyere extending into the interior of the furnace in order to ensure that the carbonaceous material is delivered to a reaction zone within the furnace.

The drawback of some conventional carbonaceous materials used in metallurgical furnaces (particularly diesel and fuel oils) is that they are relatively expensive, adding significantly to the costs of operating the furnace.

On the other hand, coal is a relatively cheap carbonaceous fuel and reducing agent. However, if lump carbonaceous material is added to a furnace, there can be a delay between the addition and the combustion of the carbonaceous material, thereby making the furnace difficult to control. If fine carbonaceous material is added to the furnace, problems with fine particles being lost to exhaust can be encountered. In addition, the use of pneumatically-conveyed particles carries a risk of spontaneous combustion, which can cause equipment damage as well as injury or death to workers.

Thus, there would be an advantage if it were possible to provide a method of operating a furnace (or of operating a furnace including a lance) that used a relatively cheap fuel/reducing agent but that also maintained good control over the conditions within the furnace.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method of operating a furnace, in particular a furnace including a lance, which may at least partially overcome at least one of the abovementioned disadvantages or provide the consumer with a useful or commercial choice.

With the foregoing in view, the present invention in one form, resides broadly in a method of operating a furnace wherein a slurry containing carbonaceous material is added to the furnace as a fuel and/or reducing agent.

It will be understood that the term “slurry” as used herein is intended to refer to a fluid mixture of a solid and a liquid. It will also be understood that solid particles having an inherent moisture content will not comprise a slurry within the meaning understood by a skilled addressee. Further, a skilled addressee would understand that solid particles having a total moisture content below approximately 10 wt % will not comprise a slurry.

The furnace may be of any suitable type. For instance, the furnace may be an electric arc furnace, flash smelting furnace, flash converting furnace, shaft furnace (such as a blast furnace), lance injection furnace and so on.

Although it is envisaged that the furnace could be any suitable metallurgical furnace, it is envisaged that the furnace will most preferably be a furnace in which fuel and/or a reducing agent is injected. Thus, in a preferred embodiment of the invention, the furnace comprises a lance injection furnace (such as a top submerged lance furnace) or a furnace in which tuyeres are present.

It is envisaged that the method of the present invention will be used primarily with furnaces for the pyrometallurgical treatment of base metal ores, residues, scrap and concentrates or iron ores.

The slurry may be injected through any suitable lance. In a simple form, the lance may comprise a tube through which at least a portion of the material to be added to the furnace is injected. Alternatively, the lance may comprise one or more tubes of varying diameter. In this embodiment of the invention, the lance may be formed as a series of concentric tubes or pipes (for instance, located substantially co-axially with one another), and one or more of the materials to be added to the furnace may be added through each concentric tube. For instance, if a lance comprises a pair of concentric tubes, the slurry may be injected through an inner tube, while other materials (such as air or oxygen) may be injected through an outer tube.

The slurry may be of any suitable ratio of liquid to solids. It is envisaged, however, that the slurry may contain the highest percentage by weight of solids as possible without causing problems with sedimentation in pipes, sumps, tanks or the like. Preferably, the slurry contains up to 70 wt % solids, more preferably between 10 wt % and 70 wt % solids, still more preferably between 30 wt % solids and 70 wt % solids.

The liquid used in the slurry may be any suitable liquid, or combination of liquids. In a preferred embodiment, however, the liquid may be water.

As previously stated, the solids within the slurry are of a carbonaceous material. Any suitable carbonaceous material may be used, although in a preferred embodiment of the invention, the carbonaceous material comprises petroleum coke, metallurgical coke, lignites or bituminous coal or a combination thereof. Any suitable particle size of the carbonaceous material may be used, although in a preferred embodiment of the invention, the particle size of the carbonaceous material is relatively fine so as to minimise any delay between the addition of the slurry to the furnace and the combustion of the carbonaceous material.

In a preferred embodiment of the invention, the carbonaceous material has been pulverised or ground. Thus, in some embodiments of the invention, the particle size of the carbonaceous material may have a D80 of between 5 and 200 μm, more preferably of between 5 and 175 μm, more preferably of between 5 and 150 μm, more preferably of between 5 and 125 μm, yet more preferably of between 5 and 100 μm, and still more preferably between 5 and 20 μm.

In other embodiments of the invention, it may be desired to provide carbonaceous material having a coarser particle size. In this embodiment of the invention, the particle size may of the carbonaceous material may have a D80 of between 10 and 400 μm, more preferably between 10 and 300 μm, more preferably between 10 and 200 μm, even more preferably between 10 and 100 μm, yet more preferably between 20 and 80 μm, and still more preferably between 40 and 60 μm.

As previously stated, the carbonaceous material may be coal. Apart from being pulverised, the coal may be untreated, or may have been otherwise treated prior to pulverisation. For instance, the coal may be washed or cleaned coal, coal that is the product of an industrial process (such as a froth flotation process, a gravity separation process or a dense medium separation process), reduced ash coal, or a combination thereof.

In some embodiments of the invention, a combination of the slurry and other carbonaceous material may be added to the furnace. For instance, lump coal may be added to the furnace in combination with the slurry.

It is envisaged that, upon injection of the slurry into the furnace, the liquid in the slurry will vaporise and the carbonaceous material will undergo combustion. It has surprisingly been found that the vaporisation of the liquid and the combustion of the carbonaceous material occurs at different distances from the tip of the lance (or tuyere). Preferably, vaporisation of the liquid in the slurry occurs at a distance from the tip of the lance that is less than the distance from the tip of the lance at which combustion of the carbonaceous material occurs.

It is envisaged that the vaporisation of the liquid at a point relatively close to the tip of the lance will generate a region of localised cooling adjacent the tip of the lance. This localised cooling provides a number of benefits, including increasing the thickness of frozen slag on the tip of the lance which in turn results in lances having a longer operational life. This longer operational life also results in fewer furnace shutdowns for maintenance, and therefore increased productivity through longer operating time. In addition, the rate of chemical corrosion occurring in the lance itself may be reduced due to the lance being cooled.

In addition to this, the combustion of the carbonaceous material at a point further from the tip of the lance than the vaporisation of the liquid results in an increase in heat in the bath, thereby substituting the role that conventional fuels (such as diesel or fuel oils) would otherwise perform in the furnace (or, at the very least, minimising the requirement to add additional to the furnace).

This is a surprising finding, as previously it has been considered that the addition of excess liquid to a furnace is highly undesirable due to the lower calorific value of a fuel containing relatively high volumes of liquid. Furthermore, the addition of liquids such as water to a bath of molten metal in a furnace is known to be extremely dangerous and can result in explosions that could cause significant damage to property and injury or death to workers.

The liquid content in the slurry (and/or the particle size of the carbonaceous material) may be varied so as to control the degree of cooling at the tip of the lance. Thus, in a preferred embodiment of the invention, the liquid content (and therefore the percentage of solids in the slurry) may be adjusted according to operational requirements. For instance, an increase in the liquid content in the slurry may increase the volume of liquid that vaporises near the tip of the lance. Thus, increased cooling may result. Similarly, a decrease in the liquid content may decrease the volume of liquid that vaporises near the tip of the lance. Thus, decreased cooling may result. It will be understood that the liquid content in the slurry may be adjusted in response to operating conditions within the furnace, such as those caused by changes in the composition of the charge (i.e. ore or concentrate) to the furnace or the like.

In the present invention, it has been found that the slurry may have up to a 50% lower calorific value than more conventional fuels per unit of carbonaceous material due to the liquid present in the slurry.

In another aspect the invention resides broadly in a system for the pyrometallurgical treatment of ores or concentrates, the system comprising a furnace, a supply of particulate material, the particulate material including carbonaceous material, a supply of liquid, mixing apparatus for mixing the particulate material and liquid to form a slurry and an injection assembly for injecting the slurry into the furnace.

In some embodiments of the invention, the system may further comprise a size reduction portion. The size reduction portion may be of any suitable form, and may include any suitable size reduction apparatus, including one or more crushers, grinding mills, or the like, or any suitable combination thereof. It will be understood that the size reduction portion may be provided so as to ensure that the particle size of the particulate material is suitable for use in the furnace.

Alternatively, the particulate material may be provided to the system at the desired particle size range, meaning that a size reduction portion is not required. For instance, the particulate material may be produced using separation, beneficiation and/or classification processes that produce the desired particle size range without requiring size reduction processes to be performed. It is envisaged that the separation, beneficiation and/or classification processes may include one or more of froth flotation, screening, jigging, dense medium separation, magnetic separation or the like. In some embodiments of the invention, the system may further comprise a separation, beneficiation and/or classification portion.

In yet another aspect, the invention resides broadly in a metallurgical furnace comprising a reaction vessel, a supply of particulate material, the particulate material including carbonaceous material, a supply of liquid, mixing apparatus for mixing the particulate material and liquid to form a slurry and an injection assembly for injecting the slurry into the reaction vessel.

In some embodiments of the invention, the metallurgical furnace may be associated with one or more size reduction devices. The size reduction devices may be of any suitable form, including one or more crushers, grinding mills, or the like, or any suitable combination thereof. It will be understood that the size reduction devices may be provided so as to ensure that the particle size of the particulate material is suitable for use in the furnace

In an alternative embodiment of the invention, the particulate matter used in the furnace may be provided at a desired particle size range. This desired particle size range may be achieved through the use of one or more separation, beneficiation and/or classification processes that produce the desired particle size range without requiring size reduction processes to be performed. It is envisaged that the separation, beneficiation and/or classification processes may include one or more of froth flotation, screening, jigging, dense medium separation, magnetic separation or the like. Thus, in some embodiments of the invention, the metallurgical furnace may be associated with one or more separation, beneficiation and/or classification devices.

The injection assembly for injecting the slurry into the furnace or reaction vessel may be of any suitable form. Preferably, however, the injection assembly comprises one or more lances or tuyeres.

The mixing apparatus may be of any suitable form, provided that the mixing apparatus is capable of forming a slurry from the particulate material and the liquid. The mixing apparatus may be located at any suitable location relative to the furnace. For instance, the particulate material and the liquid may be added to the lance, and sufficient mixing or agitation may occur in the lance to result in the formation of a slurry. Alternatively, a mixing apparatus in the form of a chamber, tank or the like may be located immediately prior to the furnace so that the slurry is formed and then immediately injected into the furnace or reaction vessel.

In another embodiment, the mixing apparatus may be located remote from the furnace or reaction vessel. In this embodiment of the invention, the slurry may be formed remotely to the furnace and then transferred (such as by pumping or under gravity etc.) to the furnace.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a schematic view of a method according to an embodiment of the present invention.

### DESCRIPTION OF EMBODIMENTS

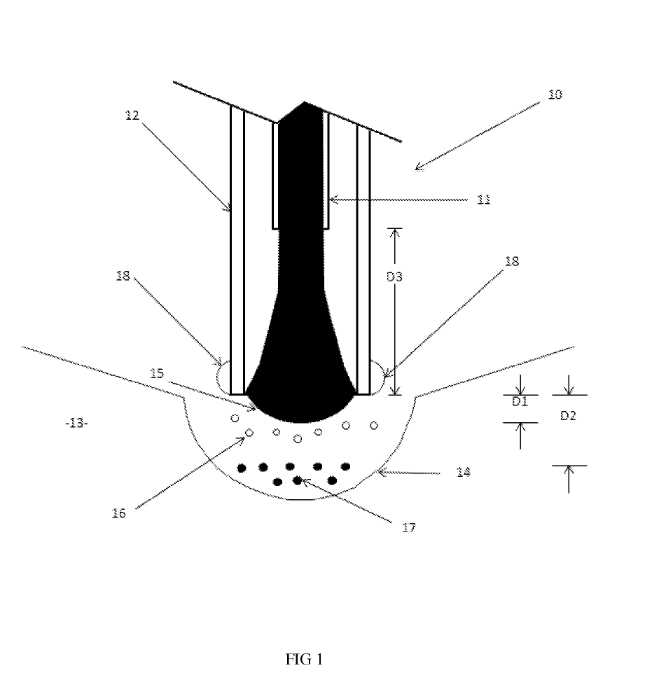

In FIG. 1 there is shown a schematic view of a method according to an embodiment of the present invention. This Figure shows a top submerged lance 10 positioned within a furnace (not shown). The lance 10 comprises a pair of concentric pipes including an inner pipe 11 through which fuel and reducing agents are supplied to the furnace, and an outer pipe 12 through which air or oxygen is supplied to the furnace. The inner pipe 11 discharges fuel (in the form of coal slurry 15) into the furnace a distance D3 from the tip of the inner pipe 11. The distance D3 is always greater than zero.

The injection of air or oxygen into a bath 13 of molten slag creates a bubble 14 of air around the tip of the lance 10 that functions as a reaction zone.

In the embodiment of the present invention shown in FIG. 1, coal slurry 15 (being a mixture of pulverised coal and water) is injected through the lance 10 into the bubble 14. The water (represented by circles 16) in the slurry 15 vaporises at a first distance D1 from the tip of the lance 10.

The vaporisation of the water 16 is endothermic and the necessary heat of vaporisation is absorbed from the surroundings, thereby creating a cooled region around the tip of the lance 10. The presence of the cooled region results in frozen slag 18 coating the outer surface of the lance 10, thereby protecting the lance 10 from corrosion and extending its operational life.

The cooled region also cools the lance, thereby reducing chemical reactions within the lance 10, also extending the operational life of the lance 10.

Once the water 16 vaporises, coal particles (represented by circles 17) continue to travel towards the interface of the bath 13 within the bubble cavity (pocket 14) created by the lance 10. Combustion of the coal particles 17 occurs at a second distance D2 from the tip of the lance 10. Although the distances D1 and D2 may vary depending on a number of factors (water content in the slurry, size of the coal particles, the velocity at which the slurry is injected through the lance and so on) distance D2 will always be greater than distance D1. Combustion of the coal particles 17 is an exothermic reaction and the heat of combustion provides heat to the bath 14.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method of operating a furnace wherein a slurry containing carbonaceous material is added to the furnace as a fuel and/or reducing agent.

2. A method according to claim 1 in which the furnace is used in the pyrometallurgical treatment of base metal ores, residues, scrap and concentrates, or iron ores.

3. A method according to claim 1 in which the slurry is injected into the furnace through a lance or tuyere.

4. A method according to claim 3 wherein the carbonaceous material in the slurry combusts at a point further from a tip of the lance or tuyere than a point at which liquid in the slurry vaporizes.

5. A method according to claim 1 wherein the slurry contains up to 70 wt % solids.

6. A method according to claim 1 wherein the carbonaceous material comprises petroleum coke, metallurgical coke, lignites, bituminous coal, or a combination thereof.

7. A method according to claim 1 wherein the particle size of the carbonaceous material has a D₈₀ of between 5 μm and 200 μm.

8. A method according to claim 1 wherein lump coal is added to the furnace in combination with the slurry.

9. A system for the pyrometallurgical treatment of ores or concentrates, the system comprising a furnace, a supply of particulate material, the particulate material including carbonaceous material, a supply of liquid, mixing apparatus for mixing the particulate material and liquid to form a slurry and an injection assembly for injecting the slurry into the furnace.

10. A system according to claim 9 wherein the system further comprises a size reduction portion.

11. A system according to claim 10 wherein the size reduction portion comprises one or more crushers, grinding mills or a combination thereof.

12. A system according to claim 9 wherein a desired particle size range of the carbonaceous material is produced using separation, beneficiation and/or classification processes.

13. A metallurgical furnace comprising a reaction vessel, a supply of particulate material, the particulate material including carbonaceous material, a supply of liquid, mixing apparatus for mixing the particulate material and liquid to form a slurry and an injection assembly for injecting the slurry into the reaction vessel.

14. A metallurgical furnace according to claim 13 wherein the metallurgical furnace is associated with one or more size reduction devices.

15. A metallurgical furnace according to claim 14 wherein a desired particle size range of the carbonaceous material is produced using separation, beneficiation and/or classification processes.

16. A metallurgical furnace according to claim 13 wherein the injection assembly comprises one or more lances or tuyeres.
